(19) United States
(12) Patent Application Publication
(10) Pub. No.: US 2017/0280408 A1
(43) Pub. Date: Sep. 28, 2017

(54) COMMUNICATION NETWORK INCLUDING TRANSMITTER REGISTRY AND ASSOCIATED METHODS

(71) Applicant: MicroCast Communication, LLC, Lake St. Louis, MO (US)

(72) Inventor: Carey James Kriz, Annapolis, MD (US)

(21) Appl. No.: 15/620,151

(22) Filed: Jun. 12, 2017

Related U.S. Application Data
(63) Continuation of application No. 15/534,738.
(60) Provisional application No. 62/095,825, filed on Dec. 23, 2014.

(51) Int. Cl. H04W 60/00; H04W 4/02

(52) U.S. Cl. CPC H04W 60/00; H04W 4/02

(57) ABSTRACT

A communication network includes a plurality of transmitters, each configured to broadcast a signal including a known transmitter identifier. The network includes a registry stored on a computer. The registry includes a transmitter data structure including a plurality of records and a channel data structure including a plurality of channels. Each channel is associated with at least one of the records and links each of its associated records with a behavior. The network also includes a wireless communication device configured to receive an incoming transmitter identifier. The device sends a request including the incoming transmitter identifier to the registry. The computer responds to the request by locating one of the records corresponding to the incoming transmitter identifier, locating at least one of the channels associated with the located record, and sending a behavior linked to the located record by the located channel to the mobile device.

### CROSS-REFERENCE TO RELATED APPLICATION

This application is a continuation of U.S. patent application Ser. No. 15/534,738 filed Jun. 9, 2017, which is a U.S. national phase application of International Application No. PCT/US2015/066239 filed Dec. 17, 2015, which claims the benefit of U.S. Provisional Patent Application No. 62/095,825, filed Dec. 23, 2014, the contents of which is incorporated herein by reference.

### FIELD

The invention relates to communication networks, and more particularly, to systems and methods of using a registry to manage a plurality of transmitters.

### BACKGROUND

Transmitters (also referred to as “beacons”) are increasingly being used by content providers to drive content to users, for example, inside retail stores for mobile applications to support rapid payment systems and advertising, among other services. Transmitters are currently used as a way of pinpointing a physical location and allowing an application to match the physical location defined by the transmitter with relevant content.

However, transmitters typically serve only a single purpose and are linked to a single application, and are typically not used by parties other than the transmitter owner. For example, a mobile payment company may set up a network of transmitters within a store to collect payments from its customers, but the store owner may not use the same transmitters to send advertisements to the same customers.

Thus, it would be desirable to provide improved communication networks for, and methods of, allowing transmitters to support multiple application developers and uses.

### SUMMARY

According to an exemplary embodiment of the invention, a communication network is provided. The communication network includes a plurality of transmitters, a registry stored on a computer, and a wireless communication device in communication with the computer. The plurality of transmitters are each configured to broadcast a signal including a known transmitter identifier. The plurality of transmitters includes a first transmitter owned by a first owner broadcasting a first transmitter identifier, and a second transmitter owned by a second owner broadcasting a second transmitter identifier. The registry includes a transmitter data structure and a channel data structure. The transmitter data structure includes a plurality of records including a first record including the first transmitter identifier, and a second record including the second transmitter identifier. Thus, each of the records includes the known transmitter identifier for a corresponding transmitter. The channel data structure includes a plurality of channels. Each of the channels is associated with at least one of the records and links each of its associated records with a behavior. The wireless communication device is configured to receive a signal including an incoming transmitter identifier, and to send a request including the incoming transmitter identifier to the registry. The computer is configured to respond to the request by locating a record corresponding to the incoming transmitter identifier within the plurality of records, locating a channel associated with the located record within the plurality of channels, and sending a behavior linked to the located record by the located channel to the device.

According to another exemplary embodiment of the invention, a communication method is provided. The method includes receiving a signal from a first transmitter owned by a first owner. The signal includes a first transmitter identifier for the first transmitter. The method also includes sending a request including the first transmitter identifier to a computer including a registry. The registry includes a transmitter data structure including a plurality of records, each of the records including a known transmitter identifier, the plurality of records including a first record including the first transmitter identifier and a second record including a second transmitter identifier for a second transmitter owned by a second owner. The registry also includes a channel data structure including a plurality of channels. Each of the channels is associated with at least one of the records and links each of its associated records with a behavior. The plurality of channels includes a first channel associated with the first record. The method also includes receiving from the computer a behavior linked to the first record by the first channel, and performing an action based on the received behavior.

According to yet another exemplary embodiment of the invention, a method of administering a registry for a plurality of transmitters is provided. The method includes providing a registry stored on a computer. The registry includes a transmitter data structure including a plurality of records, each of the records including a known transmitter identifier, the plurality of records including a first record including a first transmitter identifier for a first transmitter owned by a first owner and a second record including a second transmitter identifier for a second transmitter owned by a second owner. The registry also includes a channel data structure including a plurality of channels, each of the channels being associated with at least one of the plurality of records and linking each of the associated records in the channel with a behavior. The method also includes receiving a request including an incoming transmitter identifier from a wireless communication device, locating a record corresponding to the incoming transmitter identifier within the plurality of records, locating a channel associated with the located record within the plurality of channels, and sending a behavior linked to the located record by the located channel to the wireless communication device.

According to yet another exemplary embodiment of the invention, a communication network is provided. The communication network includes a first mobile device and a second mobile device. The first mobile device includes a first transmitter, and the second mobile device includes a second transmitter. The first mobile device is configured to receive a signal from the second transmitter, and the second mobile device is configured to receive a signal from the first transmitter. The communication network also includes a registry stored on a computer. The registry includes a transmitter data structure and a channel data structure. The transmitter data structure includes a plurality of records. Each of the records includes the known transmitter identifier for a corresponding transmitter. The plurality of records includes (i) a first record including a transmitter identifier for the first transmitter, and (ii) a second record including a transmitter identifier for the second transmitter. The channel data structure includes a plurality of channels. Each of the channels is associated with at least one of the records and links each of its associated records with a behavior. The computer is configured to respond to a request including the transmitter identifier for the second transmitter from the first mobile device by (a) locating the second record, (b) locating a channel associated with the second record within the plurality of channels, and (c) sending a behavior linked to the second record by the located channel to the first mobile device. The first mobile device is configured to send a message to the second mobile device upon receiving the behavior from the computer.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a block diagram illustrating a communication network including a registry according to an exemplary embodiment of the invention;

FIG. 1B is a block diagram illustrating an example registry of the communication network of FIG. 1A according to an exemplary embodiment of the invention;

FIG. 2 is a flow diagram illustrating a method of operating the communication network of FIG. 1A according to an exemplary embodiment of the invention;

FIG. 3 is a block diagram illustrating another communication network including a registry according to an exemplary embodiment of the invention;

FIG. 4A is a block diagram illustrating an example registry of the communication network of FIG. 3 including a channel according to an exemplary embodiment of the invention;

FIG. 4B is another block diagram illustrating an example registry of the communication network of FIG. 3 including another channel according to an exemplary embodiment of the invention;

FIG. 4C is yet another block diagram illustrating an example registry of the communication network of FIG. 3 including another two channels according to an exemplary embodiment of the invention;

FIG. 4D is yet another block diagram illustrating an example registry of the communication network of FIG. 3 including another channel according to an exemplary embodiment of the invention;

FIG. 5A is yet another block diagram illustrating an example registry of the communication network of FIG. 3 including the channels of FIGS. 4A-4D according to an exemplary embodiment of the invention;

FIG. 5B is a block diagram illustrating a channel of the registry of FIG. 5A according to an exemplary embodiment of the invention;

FIG. 6 is a cartoon representation of a communication network according to an exemplary embodiment of the invention;

FIG. 7 is a cartoon representation of another communication network according to an exemplary embodiment of the invention; and

FIG. 8 is a block diagram of another communication network according to an exemplary embodiment of the invention.

### DETAILED DESCRIPTION

Exemplary embodiments of the invention include a registration service or registry for managing the physical addresses and behaviors of wireless transmitters (e.g., Bluetooth, Near Field Communication, and Wi-Fi transmitters). The registry may serve as a common resource used by transmitter manufacturers and application developers to simplify access to transmitter IDs and to enhance and increase the use of these transmitters in location-driven content applications.

Transmitters are increasingly being used to drive content inside retail stores for mobile applications that support, among other services, rapid payments and advertising. In some cases referred to as “beacons”, exemplary transmitters include small, all-in-one packages that include a battery, a radio transmitter, an antenna and supporting transmission firmware within a casing. In some cases, the battery may supply enough energy for roughly 12 months of continuous broadcasting depending on the broadcast frequency (i.e., how often the transmitter emits a signal through its antenna). In cases where there is a need to ensure continuous and long-term broadcasting for a transmitter device, a power supply can be included through a USB or other power connection.

While the connection of a single transmitter to a single application is a hallmark of the current industry, the registry of the invention instead takes each of these single purpose transmitters and turns them into a potential source of infinite content for application developers through a linkage of ‘transmitter to channel to action’ packages that can support an unlimited range of transmitter-action couplings. The registry is built upon an object model in which the action caused by a transmitter can vary based on the package that has included it. The registry is designed to address the connection between a transmitter and an application through a simple standard and service that opens the precision of the ‘transmitter to channel to action’ linkage to the global development community. The registry is valuable to the global marketplace by allowing applications to separate a transmitter from being an adjunct component of a proprietary service to being an element of a broader network. As an element of a network, each transmitter has the potential to service the needs of multiple application developers and uses. Significantly, the registry is able to adapt existing transmitters to an open network without requiring any modification to the transmitters.

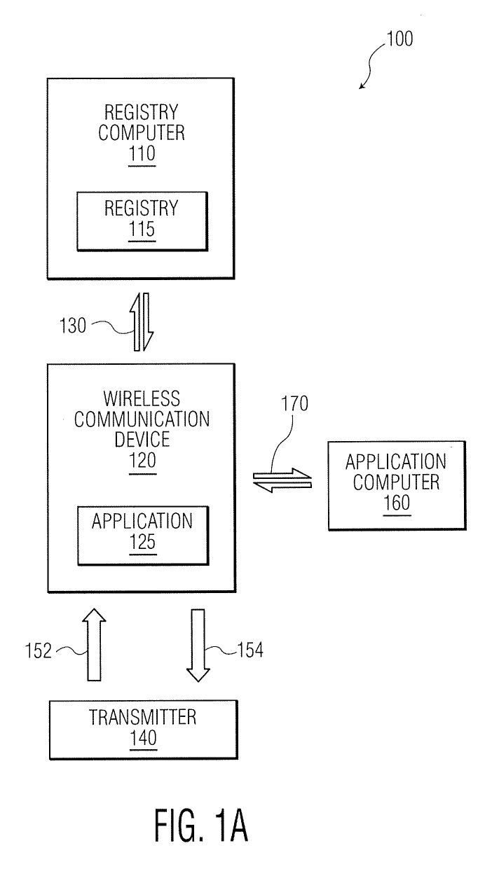

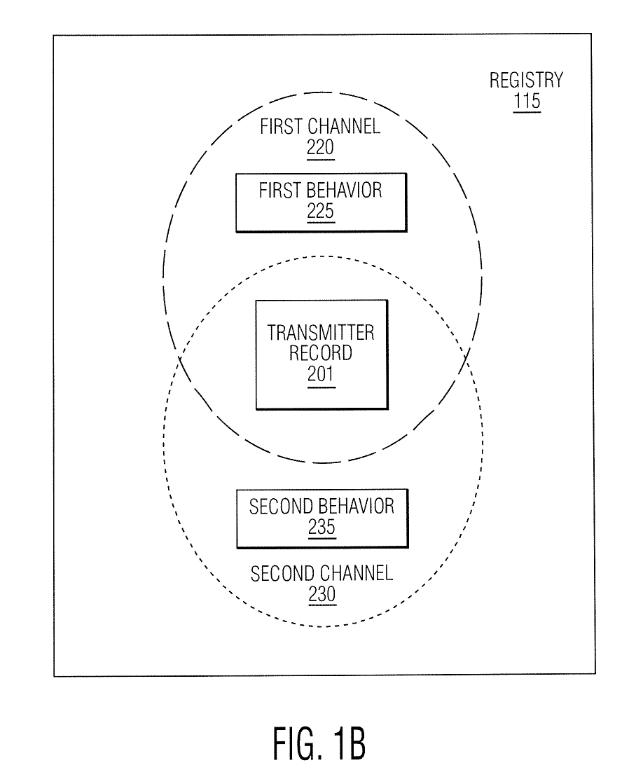

Referring now to the drawings, FIG. 1A illustrates a communication network 100 including a registry computer 110, a wireless communication device 120, a transmitter 140, and an application computer 160. A registry 115 is stored on the registry computer 110 (e.g., a server, or a distributed network of servers, etc.). By being stored on a server or a distributed network of servers, the registry 115 may run as a web service, for example, as a service accessible to users through an application programming interface (API). An application 125 is stored on the wireless communication device 120. The registry computer 110 and the wireless communication device 120 are in communication via a two-way signal 130. The wireless communication device 120 and the application computer 160 are in communication via a two-way signal 170. The two-way signals 130, 170 may be sent over a wireless network, such as a cellular network which connects to the internet or a wireless local area network (LAN). The wireless communication device 120 and the transmitter 140 are in communication via a one-way signal 152 emitted by the transmitter 140. In some embodiments the transmitter 140 may also be capable of receiving a response signal 154 from the wireless communication device 120, as described in more detail below.

As used herein, the transmitter 140 is any device capable of emitting the signal 152 which includes a known transmitter identifier which identifies the transmitter 140. The transmitter 140 may emit or broadcast the signal 152 using any typical radio frequency protocol or wireless technology including, but not limited to, Bluetooth, Bluetooth low energy (also known as “Bluetooth LE”), Near Field Communication (“NFC”), Radio-Frequency Identification (“RFID”), Wi-Fi (i.e., the IEEE 802.11 standards), and the like (collectively referred to herein as the “transmitter types”). The various transmitter types may serve different purposes based on their ranges. For example, a NFC transmitter may be used for close proximity connections (e.g., having a range of less than approximately 2 inches), while a Bluetooth LE transmitter may be used as a short range identifier (e.g., having a range of less than 50 feet). Wi-Fi transmitters may be used for general location-based services (e.g., having a range of 50 feet or more). It will be understood that embodiments of the invention are equally applicable to wireless technologies that are not yet developed but are similar to those described herein. It will be understood that the transmitter 140 may also broadcast the signal 152 using multiple different transmitter types for detection by a broader range of wireless communication devices. For example, the transmitter 140 may broadcast the signal 152 as both a Bluetooth signal and as an NFC signal.

The transmitter identifier may be any type of data broadcast by the transmitter 140 which uniquely identifies the transmitter. An exemplary transmitter identifier is a universally unique identifier (“UUID”). Different transmitters types (e.g., Bluetooth, Bluetooth LE, NFC, RFID, etc.) may have different types of transmitter identifiers. Typically, a transmitter identifier is established for a transmitter by the manufacturer of the transmitter. In some cases the transmitter identifier may be altered later by another party such as, for example, the purchaser, owner, or installer of the transmitter.

In some embodiments, the transmitter 140 is a passive device. In other words, the transmitter is a one-way device that simply transmits a data packet on the signal 152 that includes the transmitter identifier. Exemplary passive devices may include the small, all-in-one packages described above. Such all-in-one packages typically have a fixed location. Other exemplary passive devices may not have a fixed location, such as a key fob carried on a user's keychain or an access card carried in a user's wallet.

In other embodiments, the transmitter 140 may be an active device capable of performing additional functions. For example, the transmitter 140 may be a Wi-Fi access point capable of establishing a connection between the wireless communication device 120 and the internet. The transmitter 140 may also be capable of establishing the connection between the wireless communication device 120 and the registry computer 110 and between the wireless communication device 120 and the application computer 160 via the internet or another network. Also for example, the transmitter 140 may be part of a payment system (e.g., a system for processing credit card payments). Active transmitters such as Wi-Fi access points and wireless payment systems may have fixed locations, for example, in the case of a wireless payment system, the transmitter 140 may be permanently fixed in a store at a cash register. In further embodiments, the transmitter 140 may be an active device not having a fixed location, such as a mobile phone or tablet capable of both sending and receiving wireless signals.

As used herein, a “wireless communication device” is any device configured to receive the signal 152 broadcast by the transmitter 140, send a request to the registry computer 110 via the two-way signal 130, and to run the application 125 to perform an action based on a behavior received from the computer 110 in response to the request. The process of sending the request to the computer 110 and performing an action in response is described in more detail below. The wireless communication device 120 includes an antenna capable of receiving the signal 152. For example, when the transmitter 140 is a Bluetooth transmitter, the wireless communication device 120 includes a Bluetooth antenna.

Exemplary wireless communication devices include, but are not limited to, mobile devices such as smartphones, laptop computers, notebook computers, tablets, smartwatches, and the like. Such mobile devices may not have a fixed location and, for example, may be carried around by a user. In other embodiments, the wireless communication device 120 may have a fixed location for determining when a mobile transmitter 140 is in the vicinity of the wireless communication device 120. Exemplary fixed wireless communication devices include Wi-Fi hotspots and wireless payment systems. As will later be discussed, a single device may be able to operate both as a transmitter and a wireless communication device, as defined herein, but embodiments of the invention require at least two separate devices, one operating as the transmitter 140 and one operating as the wireless communication device 120. In some embodiments, each device may be acting as both the transmitter 140 and the wireless communication device 120 with respect to the other device.

Referring to FIG. 1B, and with continued reference to FIG. 1A, the registry 115 includes a transmitter record 201 corresponding to the transmitter 140. The transmitter record 201 includes the transmitter identifier of the transmitter 140. The transmitter record 201 may further include identifying information about the transmitter 140. For example, when the transmitter 140 has a fixed location, the identifying information may include geographic location information such as a latitude value and a longitude value. In another embodiment, the geographic location information may include a street address. When the transmitter 140 does not have a fixed location, for example, when the transmitter 140 is a key fob carried by a user, the identifying information may include a personal identifier of the user such as the user's name or an identification number. Other information contained in the transmitter record 201 may also include, but is not limited to, one or more of a contact information for the owner, and a subjective description of the location of the transmitter 140 (e.g., details about the environment around the transmitter 140). The registry 115 further includes one or more channels associated with the transmitter record 201, for example, a first channel 220 and a second channel 230. The transmitter record 201 may be stored in a transmitter data structure and the channels 220, 230 may be stored in a channel data structure. As used herein, “a data structure” refers to any suitable way of storing and organizing information on the registry computer 110. Exemplary data structures include, but are not limited to, tables, databases, and spreadsheets.

As part of the registry 115, each of the channels 220, 230 links the transmitter record 201 to a behavior (i.e., the channel 220 links the transmitter record 201 to a behavior 225 and the channel 230 links the transmitter record 201 to a behavior 235). Each behavior 225, 235 includes an instruction to the wireless communication device 120 to perform an action. Different channels may assign different behaviors to the same transmitter record in order for the wireless communication device 120 to perform different functions. In a preferred embodiment, the behaviors 225, 235 are stored as small data strings or bytes. While the registry 115 is capable of storing larger amounts of information as behaviors, the behaviors instead preferably instruct the application 125 to retrieve larger amounts of information from another source when necessary, such as a local storage of the wireless communication device 120 or the application computer 160. In one example, a behavior includes a web address, also known as a uniform resource locator (“URL”). In another example, each behavior 225, 235 includes the identifying information about the corresponding transmitter. The behaviors are stored as part of the registry 115, for example, as part of the channel data structure. Alternatively, the behaviors may be stored in a separate data structure (e.g., a “behavior data structure”) linked to the channel data structure.

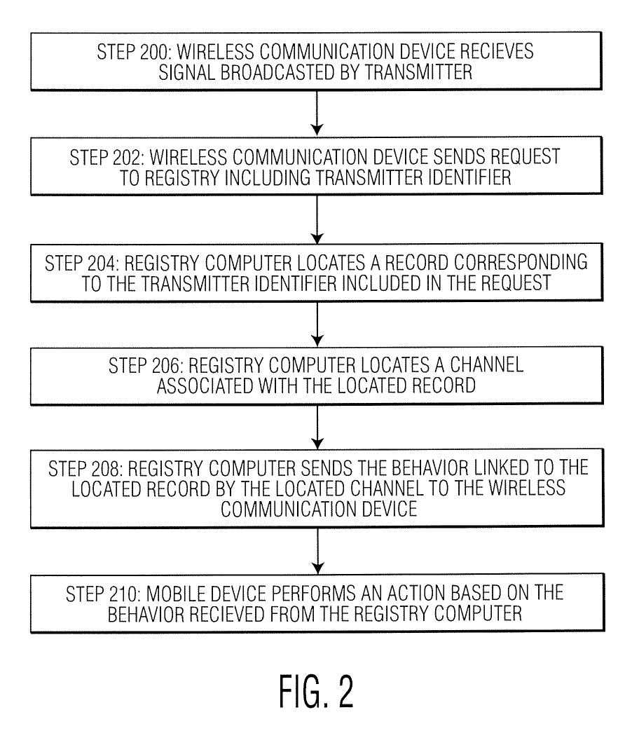

FIG. 2 is a flow diagram in accordance with an exemplary embodiment of the invention. As is understood by those skilled in the art, certain steps included in the flow diagram may be omitted; certain additional steps may be added; and the order of the steps may be altered from the order illustrated.

Referring to FIG. 2, according to another embodiment of the invention, the various components of the communication network 100 of FIGS. 1A-1B may be configured to operate according to a method depicted in FIG. 2. At Step 200, the signal 152 broadcasted by the transmitter 140, which includes the transmitter identifier, is received by the wireless communication device 120. At Step 202, the application 125 sends a request to the registry computer 110 via the wireless communication device 120, the request including the transmitter identifier of the transmitter 140. At Step 204, the registry computer 110 locates a record corresponding to the transmitter of the transmitter identifier included in the request, in this case the transmitter record 201 corresponding to the transmitter 140. At Step 206, the registry computer 110 locates a channel associated with the located record (i.e., the transmitter record 201). Depending on the request made by the wireless communication device 120, the located channel may be the first channel 220, the second channel 230, or both. At Step 208, the registry computer 110 sends the behavior linked to the located record (i.e., the transmitter record 201) by the located channel to the wireless communication device 120. For example, if the located channel is the first channel 220, the registry computer 110 sends the first behavior 225 to the wireless communication device 120. If the located channel is the second channel 230, the registry computer 110 sends the second behavior 235 to the wireless communication device 120. If the located channel is both the first channel 220 and the second channel 230, the registry computer 110 sends both the first behavior 225 and the second behavior 235 to the wireless communication device 120. At step 210, the wireless communication device 120 performs an action based on the behavior or behaviors received from the registry computer 110. In some embodiments, the action may include communicating with the application computer 160. In other embodiments, where the transmitter 140 is an active device, the action may further include communicating with the transmitter 140.

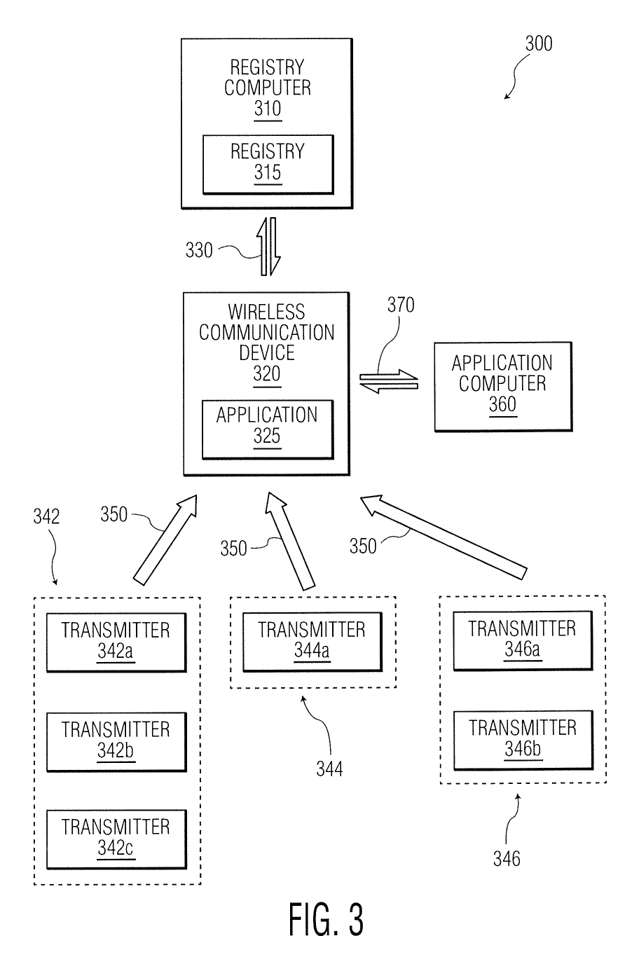

Referring to FIG. 3, another communication network 300 provided. Like the communication network 100, the communication network 300 includes a registry computer 310 (including registry 315), a wireless communication device 320 (including application 325), and an application computer 360. The registry computer 310, the wireless communication device 320, and the application computer 360 are substantially similar to the registry computer 110, the wireless communication device 120, and the application computer 160, respectively. The communication network 300 further includes multiple sets of transmitters, each set including one or more transmitters. For example, as depicted in FIG. 3, the communication network 300 includes a first set 342 including a first transmitter 342a, a second transmitter 342b, and a third transmitter 342c; a second set 344 including a fourth transmitter 344a; and a third set 346 including a fifth transmitter 346a and a sixth transmitter 346b. Each transmitter emits signals 350 (analogous to signals 152 of FIG. 1A) receivable by the wireless communication device 320. While FIG. 3 depicts a single signal 350 for each set of transmitters, it will be understood that each transmitter within a set emits its own signal. It will further be understood from the description herein that there is no upper limit to the number of transmitters or groups of transmitters included in communication networks according to embodiments of the invention. Like the transmitter 140, each transmitter of the first set 342, the second set 344, and the third set 346 is any device capable of emitting the signal 350 which includes a known transmitter identifier which identifies the transmitter. Each transmitter may emit the signal using any typical radio frequency protocol or wireless technology including, but not limited to, Bluetooth, Bluetooth LE, NFC, RFID, Wi-Fi, and the like. It will be understood that embodiments of the invention are equally applicable to wireless technologies that are not yet developed but are similar to those described herein. Each transmitter may use a different protocol or technology. For example, the first set 342 may include all Bluetooth transmitters, and the second set 344 may include a NFC transmitter. For another example, the first transmitter 342a and a second transmitter 342b may be RFID tags while the third transmitter 342c is a Wi-Fi hotspot.

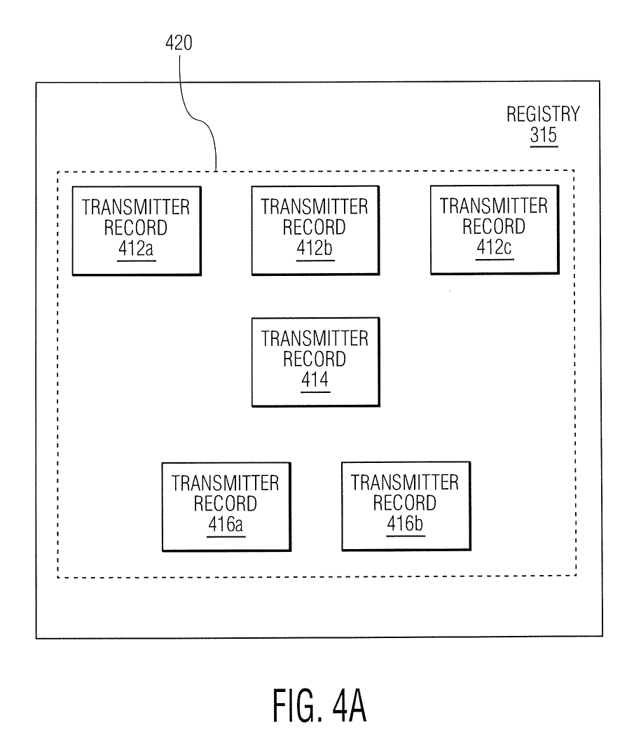

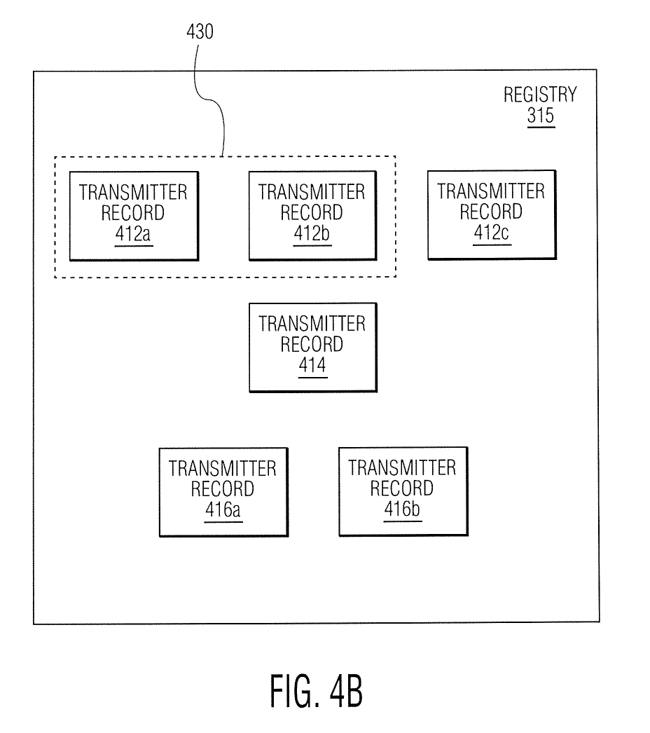

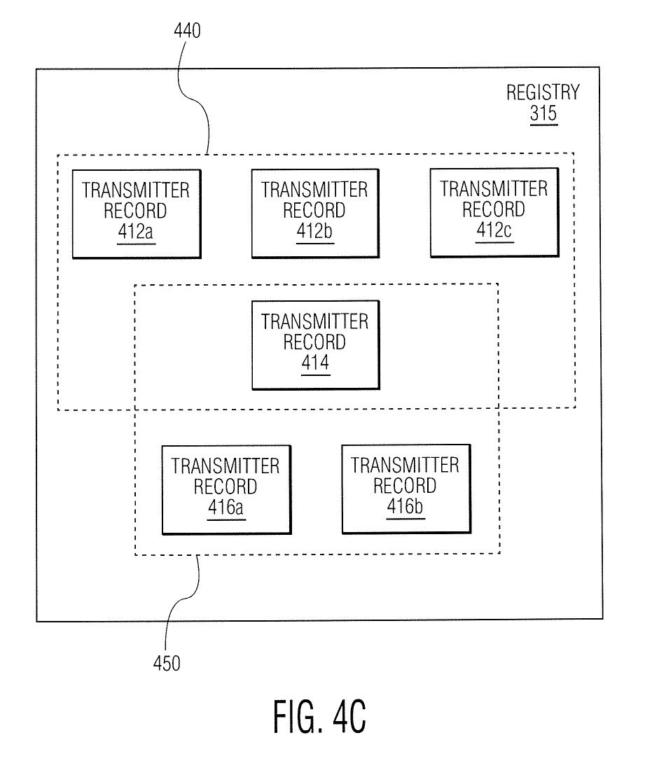

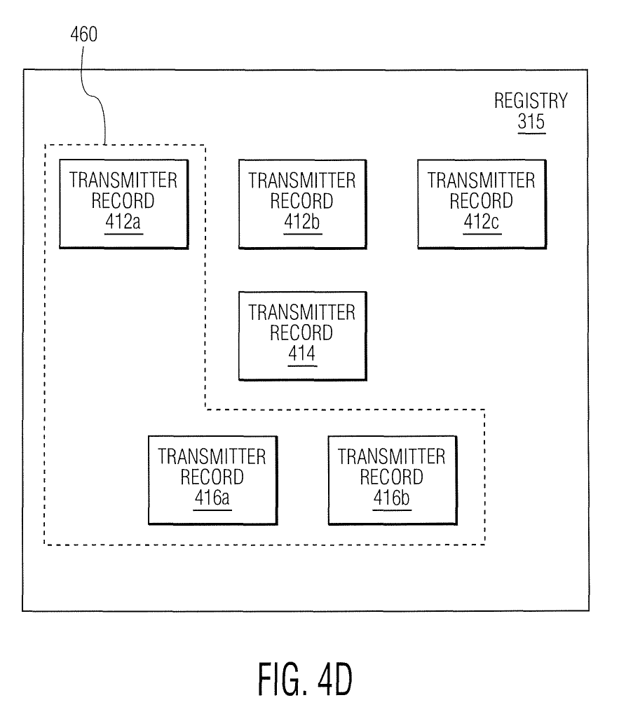

Referring to FIGS. 4A-4D, and with continued reference to FIG. 3, the registry 315 includes a transmitter record corresponding to each transmitter of the communication network 300 (i.e., transmitter record 412a corresponds to the first transmitter 342a, transmitter record 412b corresponds to the second transmitter 342b, transmitter record 412c corresponds to the third transmitter 342c, transmitter record 414 corresponds to the fourth transmitter 344a, transmitter record 416a corresponds to the fifth transmitter 346a, and transmitter record 416b corresponds to the sixth transmitter 346b). Each of the transmitter records 412a-412c, 414, 416a-416b is substantially similar to the transmitter record 201, with the exception that the information contained by each record relates to the corresponding transmitter.

The registry 315 may contain one or more channels, each channel being associated with at least one of the transmitter records 412a-412c, 414, 416a-416b. Each channel may be associated with the records of any subset of each of the sets of transmitters 342, 344, 346. For example, as depicted in FIG. 4A, a first channel 420 may include all the transmitter records 412a-412c, 414, 416a-416b. As depicted in FIG. 4B, a second channel 430 may include the records of a subset of just one set of transmitters. In this example, the second channel 430 includes transmitter record 412a and transmitter record 412b, but excludes transmitter records 412c, 414, 416a, and 416b. As depicted in FIG. 4C, channels may overlap. The registry 315 may include a third channel 440 including transmitter records 412a, 412b, 412c, and 414, and a fourth channel 450 including transmitter records 414, 416a, and 416b, with transmitter record 414 common to both the third channel 440 and the fourth channel 450. In another example, as depicted in FIG. 4D, a fifth channel 460 may include the records of a subset of one set of transmitters (e.g., transmitter record 412a, but not transmitter records 412b, 412c) and all the records of another set of transmitters (e.g., transmitter records 416a, 416b). It will be understood from the preceding examples that a registry part of a communication network according to an embodiment of the invention may include a channel including any possible subset of transmitter records ranging from one record to all the records, including combinations not specifically described herein. It will also be understood that channels may overlap by including the same record or records. Two channels may also include identical subsets of records to provide the same transmitters with different functionalities.

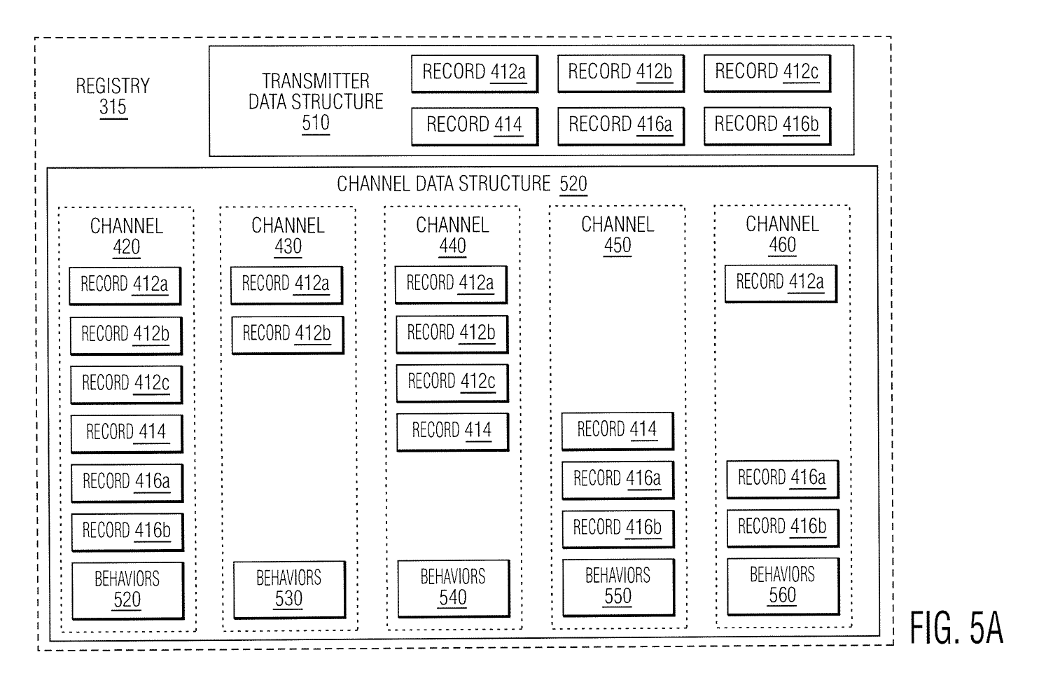

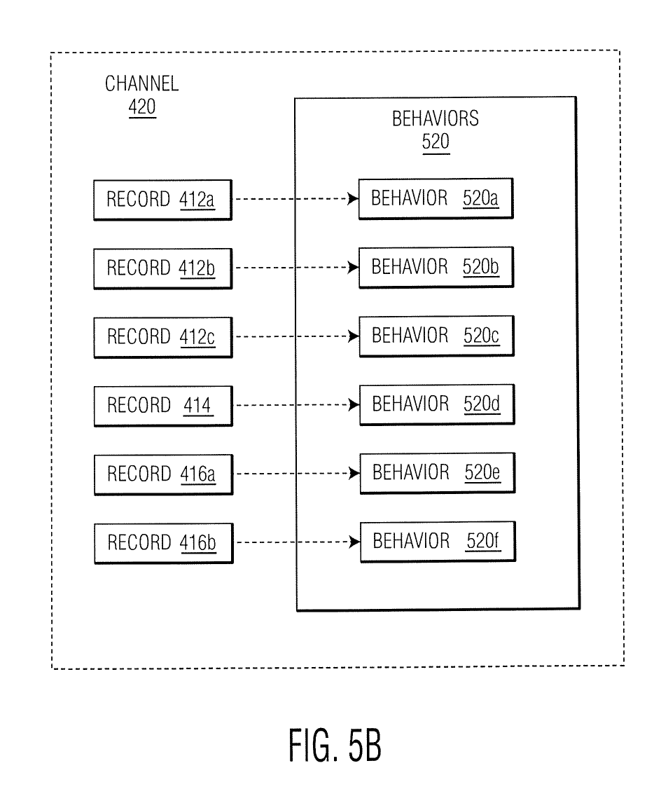

FIG. 5A depicts the registry 315 including the transmitter records 412a-412c, 414, 416a-416b and the channels 420, 430, 440, 450, and 460 organized as a transmitter data structure 510 and a channel data structure 520. Each of the transmitter records 412a-412c, 414, 416a-416b are stored as part of the transmitter data structure 510. Each of the channels 420, 430, 440, 450, and 460 are stored as part of the channel data structure 520. Each of the channels links each of the records within that channel with behaviors (e.g., first channel 420 links transmitter records 412a-412c, 414, 416a-416b with behaviors 520, second channel 430 links transmitter records 412a, 412b with behaviors 530, channel 440 links transmitter records 412a-412c, 414 with behaviors 540, fourth channel 450 links transmitter records 414, 416a-416b with behaviors 550, and fifth channel 460 links transmitter records 412a, 416a-416b with behaviors 560). As depicted in FIG. 5B, each channel may link each record associated with the channel with a separate behavior (e.g., record 412a with behavior 520a, record 412b with behavior 520b, record 412c with behavior 520c, record 414 with behavior 520d, record 416a with behavior 520e, and record 416b with behavior 520f). Alternatively, a channel may link more than one record to the same behavior, and may link the same record to more than one behavior, etc. It is noted that while FIGS. 5A-5B depict the behaviors as part of the channels, the behaviors may be in a separate data structure in the registry 315 (i.e., not the transmitter data structure 510 or the channel data structure 520) and then linked to the records by the channels.

Embodiments of the invention may further include methods for various parties to create and update the information stored in a registry, such as the registry 115 (FIGS. 1A-1B) or the registry 315 (FIGS. 3, 4A-4D, and 5A-5B).

A registry according to the invention will have three primary classes of users: transmitter owners, channel creators, and application developers. As used herein, the definition of an “owner” is not limited just to the literal owner of the transmitter, but may also include any party responsible controlling the transmitter, such as an employee of a store, where the store is the owner of the transmitter, or a third party hired by a transmitter owner to manage the transmitter. Transmitter owners may be responsible for creating and maintaining the transmitter records, channel creators may be responsible for creating channels including the transmitter records, and application developers may be responsible for developing applications that utilize the channels. One party may simultaneously be one or more of a transmitter owner, a channel creator, and an application developer. For example, a store owner may install transmitters in the store and create the associated transmitter records, create a channel of all the store's transmitter records, and then create an application for the store that uses the channel. However, the registry is defined by its ability to allow other parties to also use the same transmitter records and channels for other purposes.

Before channels can be created as part of the registry, the registry may be populated with the transmitter records. In one embodiment, the owner of a transmitter may access the registry and add a new transmitter record to the registry through a web service accessible through a web browser. The new record will include at least the transmitter identifier and the geographic location information for the transmitter identifier. As previously explained, the transmitter owner could further add additional information about the transmitter, such as the identity of the owner or a description of the transmitter's location. In another embodiment, the registry is prepopulated with transmitter records including just the transmitter identifiers provided by the manufacturer of the transmitters. After the transmitters are purchased and installed by an owner, the owner may access the registry and add the geographic location information and any additional information the owner desires.

As part of managing the transmitter record, the owner of a transmitter may further designate records as public or private. A record designated as public will be available to any party who creates a channel and wishes to include the public record. By designating a record as private, the transmitter owner may control who is able to create channels including the private record. For example, the transmitter owner may choose to not allow any party other than the owner to create channels including the private record. The registry may also include a way for parties to request access to the private record, for example, for a fee or commission negotiated between the party and the transmitter owner.

The owner of a transmitter may also define a default behavior for the transmitter record. An example of a default behavior may be a URL linking to the owner's website. The default behavior will be made available to parties creating channels including the transmitter record. Accordingly, the role of the owner of a transmitter beacon is to install the transmitter in a location, publish content related to the beacon stored in the registry, and maintain the transmitter record, updating as necessary to reflect any changes.

Once the registry is populated with transmitter records, users of the registry (i.e., the channel creators) may create channels including one or more of the records. Users interested in creating channels may include application developers interested in having a channel to define behaviors for an application. Users may also include parties interested in providing channels for applications developed for others. For example, a city or locale may create a channel of transmitter records, where the corresponding transmitters are in locations of historical significance through the city to increase tourism. The channel may then be accessible to application developers interested in that information. Accordingly, like the transmitter records, channels may be designated as either public or private. A channel creator may prefer a channel to be private if they intend to use it only with their own proprietary application, or public if they prefer it to be shared with others, either for free or in exchange for a fee or commission. A channel creator may then be able to create value without creating an application, by curating collections of transmitters for different purposes while relying on others to develop the associated applications.

An application developer may then utilize the channels included in the registry (e.g., whether a channel is created by the application developer personally, a public channel created by a third party, or a private channel created by a third party with the third party's permission) to create an application that performs an action based on the behaviors defined by the channels. An application may be developed to utilize only a single channel, or may be designed to use more than one channel. For example, an application could a browser designed to identify any public channels associated with a transmitter detected by a wireless communication device and then performing the default actions of a channel selected by a user of the application.

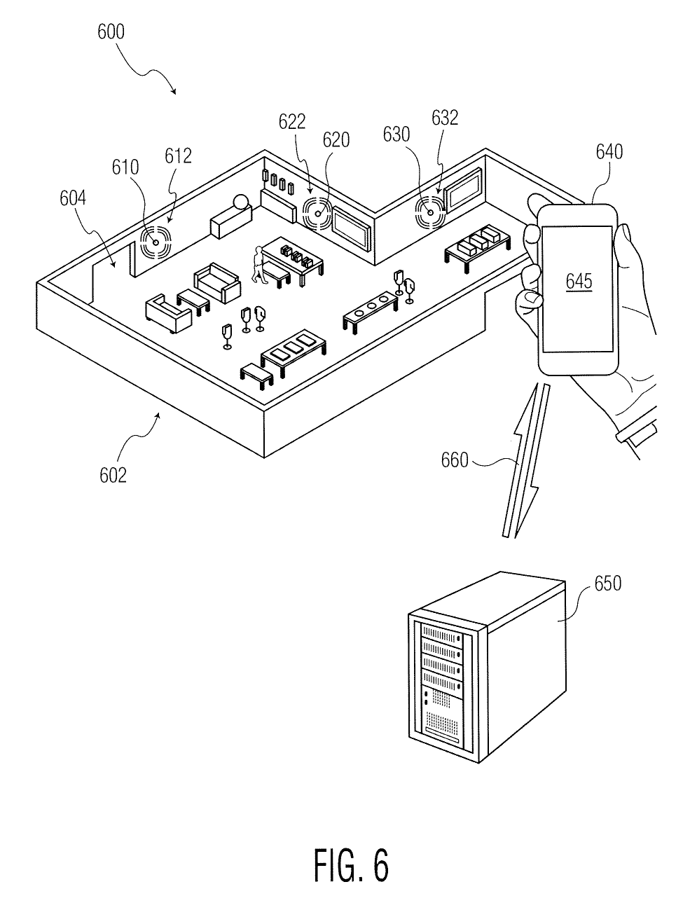

Referring to FIG. 6, an exemplary communication network 600 may be established in a store 602, for example, a department store in a shopping mall. It will be understood that the following description is of a single exemplary application of an embodiment of the invention, and that other embodiments may be established in other settings, such as, but not limited to, a restaurant, a stadium, or an amusement park. The network 600 includes a first transmitter 610 broadcasting a first signal 612, a second transmitter 620 broadcasting a second signal 622, and a third transmitter 630 broadcasting a third signal 632. Various other transmitters not shown on FIG. 6 may be set up throughout the store 602, such as a plurality of Bluetooth transmitters on each display table in the store. A person in the vicinity of the store 602 is using a wireless communication device 640 (e.g., mobile device 640) having stored on it one or more applications 645 used to interact with one or more of the first transmitter 610, the second transmitter 620, and the third transmitter 630 in various ways by receiving one or more of the first signal 612, the second signal 622, and the third signal 632. Based on receiving the signals, the application 645 will interact with a registry computer 650 (e.g., via signal 660) to perform various actions, as described in more detail above.

In one exemplary embodiment, each transmitter 610, 620, 630 may be a different type of transmitter to serve a different purpose and may have a different owner. For example, the first transmitter 610 may be a Bluetooth transmitter with a range extending only to an entrance 604 of the store 602. The store owner may install the first transmitter 610 to greet customers when entering the store who are using an application provided by the store owner. The second transmitter 620 may be a Wi-Fi transmitter installed by the shopping mall owner to provide internet access to mall visitors. Finally, the third transmitter 630 may be a NFC transmitter that is part of a payment system operated by the store owner by provided by a payment company (e.g., a credit card company).

Once transmitter records are created in a registry stored on the registry computer 650, various channels may be created with the transmitter records to enable various applications 645. For example, the payment company may create a first channel including the transmitter record for the third transmitter 630 that will be used as part of the payment system. Meanwhile, the store may create a second channel including the transmitter record for the third transmitter 630 to enable an application that includes games to entertain a child while the parent is completing a purchase. The mall may create yet a third channel including the transmitter record for the third transmitter 630 to enable an application that sends a coupon to the application user to encourage the user to visit another part of the mall once the user has completed their transaction at the store.

In another example, the store could create a channel including the transmitter records for the first transmitter 610 and the third transmitter 630 to provide information about the store. The channel could link to a first behavior for the first transmitter 610 which instructs an application to list sales currently offered by the store. The application could obtain the list of sales from an independent application server (not shown). The channel could further link to a second behavior for the third transmitter 620 which instructs an application to send a coupon to the application user when they approach the payment system.

In another example, the store/mall could create a channel including the transmitter record for the second transmitter 620, as well as a channel including the transmitter record for other Wi-Fi hotspots throughout the mall in other stores. The mall may use the channel for a system that tracks mall visitors with their permission to analyze foot traffic patterns throughout the mall. The same channel could be used for a separate application which provides a real-time directory for mall visitors. The same channel could further be used by a third party to develop an application that provides real-time directories for all the malls in the region. Such an application would also interact with other channels established by other malls or shopping centers.

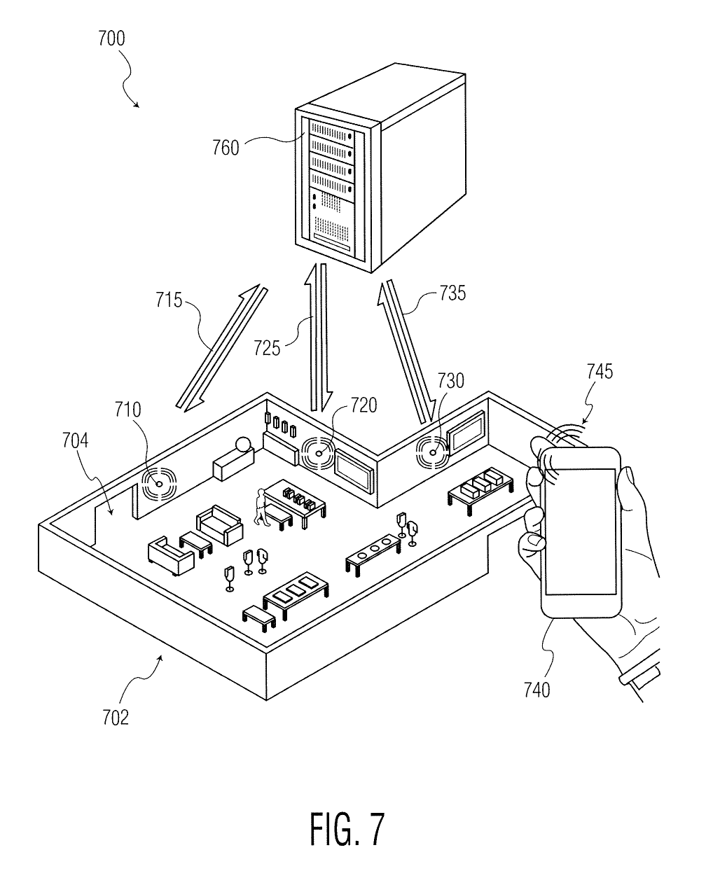

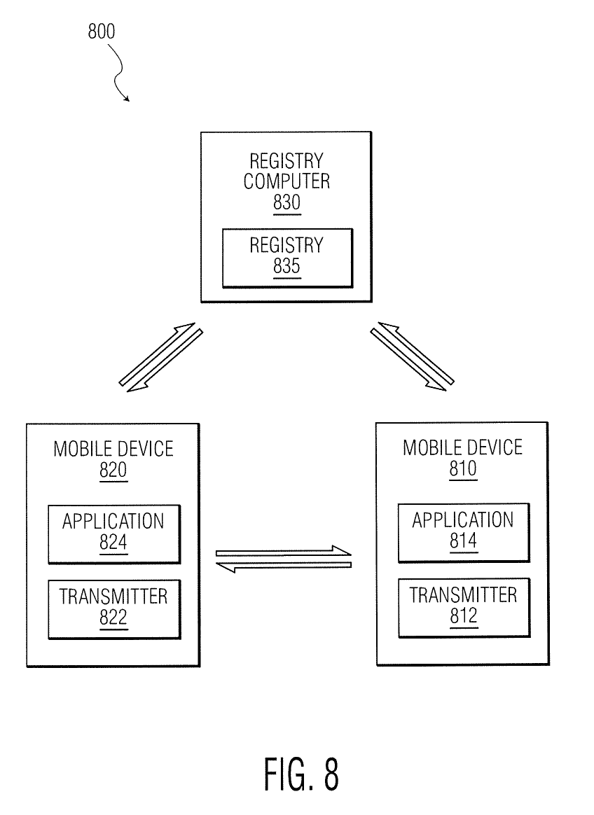

Although the invention has been primarily described with respect to fixed transmitters and a mobile wireless communication device, as in FIG. 6, it is not limited thereto. Other examples are include mobile transmitters (e.g., mobile phones, etc.) with a fixed wireless communication device, as in FIG. 7, and two mobile devices which serve as both the transmitter and the wireless communication device with respect to the other mobile device, as in FIG. 8.

Referring to FIG. 7, another exemplary communication network 700 may be established in another store 702, for example, a department store in a shopping mall. It will again be understood that the following description is of a single exemplary application of an embodiment of the invention, and that other embodiments may be established in other settings, such as, but not limited to, a restaurant, a stadium, or an amusement park. The network 700 includes a plurality of wireless communication devices including a first wireless communication device 710, a second wireless communication device 720, and a third wireless communication device 730. A person in the vicinity of the store 702 uses a mobile device 740 configured to operate as a transmitter used to interact with one or more of the wireless communication devices 710, 720, 730. In order to interact with the wireless communication devices 710, 720, 730, the mobile device 740 emits a signal 745 which may be received by one or more of the wireless communication devices 710, 720, 730. As previously explained, the mobile device 740 emits a signal 745, for example, a Bluetooth signal, a Wi-Fi signal, etc. The network 700 further includes a registry computer 760 in communication with the wireless communication devices 710, 720, 730 (e.g., in communication with the wireless communication device 710 via two-way signal 715, in communication with the wireless communication device 720 via two-way signal 725, and in communication with the wireless communication device 730 via two-way signal 735).

In one exemplary embodiment, each wireless communication device 710, 720, 730 may be configured to receive the signal from a different transmitter type to serve a different purpose and may have a different owner. For example, the first wireless communication device 710 may receive Bluetooth signals with a range extending only to an entrance 704 of the store 702 to detect when the mobile device 740 enters the store 702, the second wireless communication device 720 may receive Wi-Fi signals covering the whole store 702 to determine how many transmitters such as the mobile device 740 are in the store, and a third wireless communication device 720 may receive NFC signals to determine when the mobile device 740 is only in the direct vicinity of a payment system or cash register.

In one example, the mobile device 740 may belong to an employee of the store, and the store owner may create a channel of all the transmitter records corresponding to mobile devices belonging to the store's employees and use the first wireless communication device to track when employees enter and exit the store at the beginning and end of work shifts. In such an example, the mobile devices may be access cards issued to the employees by the store owner. When the first wireless communication device 710 located at the entrance 704 detects an access card, it sends a request to the registry computer 760 to identify the employee associated with the access card. The same store owner may also create a channel of all the transmitter records of mobile devices belonging to customers who have signed up for a loyalty program to record store visits and issue rewards and coupons. For example, when the third wireless communication device 730 (i.e., the wireless communication device located at the payment system or cash register) detects the mobile device of a customer, it sends a request to the registry computer 760 to identify the customer associated with the mobile device. Once the third wireless communication device 730 knows the identity of the customer, it may send a coupon to the mobile device during checkout. The mall owner may then use the same channel of store customers to provide cross-marketing coupons to the same customers who also install a mall directory application on their devices. It will be understood that the example applications described in conjunction with FIG. 7 operate by the various wireless communication devices sending a request including the transmitter identifier of the detected mobile device to the registry computer 760 and the registry computer 760 responding to the request with a behavior, as previously described.

Referring to FIG. 8, according to another embodiment of the invention, another exemplary communication network 800 may be used to establish a messaging system between a first mobile device 810 and a second mobile device 820. Each of the first mobile device 810 and the second mobile device 820 include a transmitter (i.e., first transmitter 812 and second transmitter 822, respectively) and are capable of receiving a signal from the other mobile device. Similar to the previous examples, each of the first mobile device 810 and the second mobile device 820 are in communication with a registry computer 830 that has stored on it a registry 835. The registry 835 includes a transmitter record for each of the transmitters 812, 822 including a transmitter identifier for each of the transmitters 812, 822. When the first mobile device 810 receives a signal from the second transmitter 822 (or vice versa), a messaging application 814 stored on the first mobile device 810 may send a request including the transmitter identifier for the second transmitter 822 to the registry computer 830 to identify the second mobile device 820. The registry computer 830, upon receiving the request, will locate the transmitter record corresponding to the received transmitter identifier, locate a channel associated with the located record (e.g., a channel also identified by the messaging application), and send a behavior linked to the located record by the located channel to the first mobile device 810. The sent behavior may include identifying information for the second mobile device 820 or the user of the second mobile device 820. Once the messaging application identifies the second mobile device 820 or the user of the second mobile device 820, the messaging application 814 allows the user of the first mobile device 810 to send a message to the second mobile device 820 (e.g., if the second mobile device 820 is using the same messaging application such as application 824). The messaging application may further include restrictions that allow the message to be read only while one of the mobile devices 810, 820 is receiving a signal from the other mobile device, ensuring that the users of both mobile devices 810, 820 are in the same physical space. The area of the physical space will depend on the sort of transmitters used by the mobile devices 810, 820 (e.g., Bluetooth transmitters will require the two users to be within 50 feet of each other while Wi-Fi transmitters would allow communication from much greater distances). Different proximities may be useful for different applications, such as social networks or dating services.

While the examples describe above in conjunction with FIGS. 6-8 each include a different registry stored on a different registry computer (e.g., registry computer 650 and registry computer 830), it will be understood that a single registry may be used as part of the different communication networks described in the examples. A single registry, capable of storing records for all transmitters regardless of their construction or intended use, is contemplated to service the needs of multiple application developers and uses.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A communication method, the method comprising the steps of:
receiving a signal from a first transmitter owned by a first owner, the signal including a first transmitter identifier for the first transmitter;
sending a request including the first transmitter identifier to a computer including a registry, the registry including
(a) a transmitter data structure including a plurality of records, each of the records including a known transmitter identifier, the plurality of records including (i) a first record including the first transmitter identifier and (ii) a second record including a second transmitter identifier for a second transmitter owned by a second owner, and
(b) a channel data structure including a plurality of channels, each of the channels being associated with at least one of the records, each of the channels linking each of the associated records in the channel with a behavior, the plurality of channels including a first channel associated with the first record;
receiving from the computer a behavior linked to the first record by the first channel; and
performing an action based on the received behavior.

2. The method of claim 1 wherein the step of performing the action includes communicating with an application server.

3. The method of claim 1 wherein the plurality of transmitters includes at least one transmitter of a transmitter type selected from the group consisting of Bluetooth transmitters, Bluetooth Low Energy transmitters, Radio Frequency Identification (RFID) transmitters, Wi-Fi transmitters, and near-field communication (NFC) transmitters.

4. The method of claim 3 wherein the first transmitter and the second transmitter are different transmitter types.

5. The method of claim 1 wherein each of the plurality of records further includes geographic location information corresponding to the respective one of the plurality of transmitters.

6. The method of claim 5 wherein the geographic location information includes a latitude value and a longitude value.

7. The method of claim 1 wherein the computer includes at least one server.

8. The method of claim 1 wherein the plurality of channels includes (a) a first channel associated the first record and (b) a second channel associated the first record.

9. The method of claim 1 wherein one or more of the plurality of records are designated as private records.

10. The method of claim 1 wherein the first transmitter and the second transmitter have fixed locations.

11. The method of claim 1 wherein the first transmitter and the second transmitter are mobile devices.

12. The method of claim 1 wherein the method is performed by a wireless communication device.

13. The method of claim 12 wherein the wireless communication device has a fixed location.

14. The method of claim 13 wherein the first transmitter and the second transmitter are mobile devices.

15. The method of claim 12 wherein the wireless communication device is a mobile device.

16. The method of claim 13 wherein the first transmitter and the second transmitter have fixed locations.
